(19) United States
(12) Patent Application Publication
(10) Pub. No.: US 2024/0117998 A1
(43) Pub. Date: Apr. 11, 2024

(54) A DEVICE FOR HEATING A MEDIUM AND AIR

(71) Applicant: TRUMA GERAETETECHNIK GMBH & CO. KG, Putzbrunn (DE)

(72) Inventors: Thomas HARTMANN, Putzbrunn (DE); Bernhard STAHL, Putzbrunn (DE)

(21) Appl. No.: 18/265,481

(22) PCT Filed: Jan. 3, 2022
(86) PCT No.: PCT/EP2022/000003

§ 371 Date: Jun. 6, 2023

(30) Foreign Application Priority Data
Mar. 1, 2021 (DE) 102021001082.5

(51) Int. Cl. F24H 6/00; F24H 1/16; F24H 3/06; F28D 7/02; F28D 7/10

(52) U.S. Cl. CPC F24H 6/00; F24H 1/162; F24H 1/165; F24H 3/062; F24H 3/065; F28D 7/024; F28D 7/10

(57) ABSTRACT

Example embodiments relate to a device for heating a medium and air. A heating source generates thermal energy by the combustion of a fuel-air-mixture. A heat exchanger serves to heat air passed along an exterior side, has an interior space into which flue gas generated during combustion of the fuel-air-mixture flows, has a fin structure on the exterior side, and transmits thermal energy to the medium pipe. The electric heating element generates thermal energy, the heat exchanger having integral structures for accommodating the electric heating element and the medium pipe. The medium pipe and the electric heating element are guided around the interior space of the heat exchanger.

### FIELD OF DISCLOSURE

This disclosure relates to a device for heating at least one medium and air. The medium is water, for example.

### BACKGROUND

Document DE 41 16 692 A1 describes an air heater apparatus in which a heat exchanger insert transmits thermal energy from combustion gases to room air. Alternatively, it is indicated that the heat exchanger insert is surrounded by a water ring container so that water can be heated. DE 10 2018 006 595 A1 describes a heat exchanger in which electric heating elements can be incorporated as a secondary heating source. A heat exchanger having exterior fins and electric heating elements and serving to heat air is described in document EP 2 462 385 B1. A device for heating air and water is shown in WO 2020/100085 A1. An electric heating element and a water pipe are located within a heat exchanger over which air flows. Concentric guides of heating elements and water pipes are disclosed in KR 100575278 B1 or US 2004/0154312 A1.

The prior art has the drawback that it usually involves very complex apparatuses composed of a variety of components the manufacture of which is in particular very expensive.

### SUMMARY

An object on which the example embodiments are based is to propose a device for heating a medium and air.

The device allows heating of a medium and air. It is thus possible that either only the medium or only air alone is heated, or that the medium and air are heated jointly. For example, only the medium is heated by the electric heating element, even if the heating source is not operating. If conversely no medium is passed through the medium pipe, the device operates as a pure air heater. The device has a heating source and at least one electric heating element which both generate thermal energy which serves to heat the medium. The thermal energy of the heating source generated by the combustion of a fuel-air mixture is indirectly supplied to the at least one medium pipe and thus to the medium passed in the medium pipe via the heat exchanger. Furthermore, the heat exchanger heats air which is passed along an exterior side. The heat exchanger has an interior space in which flue gas generated during combustion of the fuel-air mixture flows. The heat exchanger has a fin structure on the exterior side. Preferably, the electric heating element is directly thermally coupled to the medium pipe. The heat exchanger is configured such that both the electric heating element and the medium pipe are at least partially guided therein. The heat exchanger thus at least partially accommodates the electric heating element and the medium pipe. To this end, the heat exchanger has integral structures via which the heat exchanger also acts as a support for the electric heating element and the medium pipe. Due to the integral structures, no additional fastening or fixing components are necessary. Furthermore, for the manufacture, a common component can already be produced from the heat exchanger, the electric heating element and the medium pipe. By guiding the medium pipe—preferably concentrically—around the interior space of the heat exchanger, it is wound around the interior space in the heat exchanger and preferably also has an axial extension along a longitudinal axis of the heat exchanger. By guiding the electric heating element—preferably concentrically—around the interior space of the heat exchanger, it is configured in the manner of a heating coil which is located around the interior space of the heat exchanger and extends preferably along a longitudinal axis of the heat exchanger.

In one configuration, the heat exchanger completely accommodates the heating element and the medium pipe with the exception of connecting components or connecting sections.

In one configuration, the heating source has at least a burner in which a gas-air mixture or a Diesel-air mixture as examples for a fuel-air mixture are burned. The flue gas thus produced is introduced into the interior space of the heat exchanger.

In one configuration, the electric heating element is cast into the heat exchanger.

In one configuration, the medium pipe and the electric heating element are guided concentrically around the interior space of the heat exchanger, and additionally, the medium pipe and the electric heating element also extend axially along a longitudinal axis of the heat exchanger. In one configuration, the axial extension is at least equal to the height of the interior space of the heat exchanger.

According to one configuration, the medium pipe and the electric heating element are guided parallel to each other. In one configuration, the medium pipe and the electric heating element are adjacent to each other and are both guided around the interior space of the heat exchanger and over an axial extension along the interior space.

One configuration consists in that there is as little thermal resistance as possible between the medium pipe and the electric heating element. In an alternative or complementary configuration, the medium pipe and the electric heating element are in thermal contact with each other. In this configuration, the electric heating element allows the direct heating of the medium in the medium pipe.

In one configuration, the integral structures of the heat exchanger are configured in a tubular shape. In one configuration, two tubes are provided in which the medium pipe and the electric heating element are each separately guided and/or cast. In one alternative configuration, only one tube is provided which accommodates the medium pipe and the electric heating element together.

In one configuration, the medium pipe and the integral structure for the medium pipe are integrated in a unit. The heat exchanger thus has a tubular structure through which the medium is passed.

According to one configuration, the device has two electric heating elements, and the integral structures at least partially accommodate the two electric heating elements. In this configuration, there are two electric heating elements which may be of identical or different design. In one variant, these are two heating coils. The two electric heating elements are each incorporated in the structures of the heat exchanger.

One configuration consists in that the heat exchanger is at least partially made of a die-cast or of a sintered material.

According to one configuration, the heat exchanger is made in one piece or in several pieces.

### BRIEF DESCRIPTION OF DRAWINGS

More specifically, there are multiple possibilities for designing and further developing the device according to the invention. To this end, reference is made on the one hand to the claims subordinate to the independent claim, and on the other hand to the description below of example embodiments in conjunction with the drawing in which:

FIG. 1: shows a schematic representation of the device with respect to the transfer of thermal energy to the medium,

FIG. 2: shows a truncated spatial representation of a first configuration of a heat exchanger according to the invention, and

FIG. 3: shows a truncated spatial representation of a second configuration of a heat exchanger according to the invention.

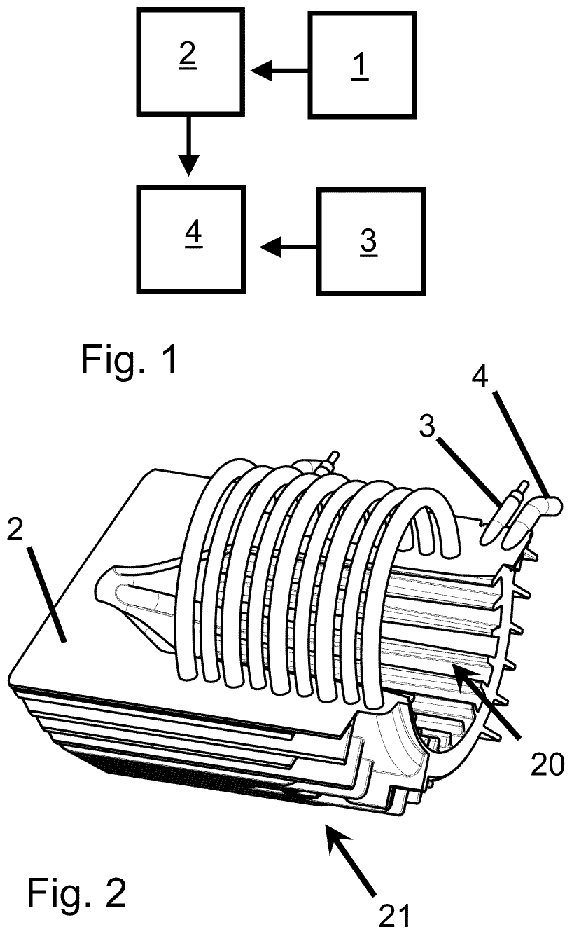

FIG. 1 schematically shows a device for heating a medium which is water, for example, and air.

### DETAILED DESCRIPTION OF EXAMPLE EMBODIMENTS

In some implementations, a heating source 1 generates thermal energy—by the combustion of a gas-air or a Diesel-air mixture in a burner, for example—which is transferred to the medium to be heated via a heat exchanger 2. The medium is guided in a medium pipe 4, for which a pump is provided in a variant not shown here. The electric heating element 4 is directly thermally coupled to the medium pipe 4 to use the generated thermal energy for heating the medium. Preferably, a control or regulating unit (not represented here, either) is provided for the electric heating process. In this configuration, the medium is thus heated by a combustion process and additionally or alternatively by electric energy. In case the device serves as an air heater, air is passed along the heat exchanger 2. The thermal energy is derived from the heating source 1 or from the electric heating element 3. The thermal energy can also be derived from the heating source 1 and the electric element 3. The electric element 3 transfers its thermal energy to the heat exchanger 2 which in turn heats the air guided past it. Finally, air and the medium can be heated simultaneously.

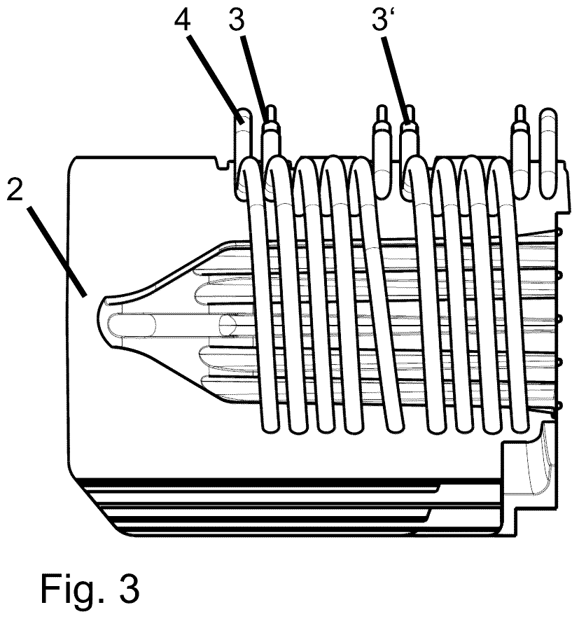

FIG. 2 shows a partially truncated spatial representation of a first configuration of a heat exchanger 2 according to the invention. The heat exchanger 2 has an interior space 20 in which the flue gas of the heating source—indicated in FIG. 1—is introduced. This thermal energy in the interior space 20 is transferred by the heat exchanger 2 to the outside so that air which is passed along the exterior side of the heat exchanger 2 can also be heated. To this end, a fan (not represented) is provided, for example. The fin structure 21 provided here on the exterior side of the heat exchanger 2 also serves to transfer the thermal energy to the air. Here, the medium pipe 4 is guided concentrically and along an axial extension around the interior space 20. The medium pipe 4 is thus wound around the interior space 20 and is thus also guided axially along the interior space 20. The electric heating element 3 extends parallel to the medium pipe 4. This is intended to generate a thermal resistance which is as low as possible. The electric heating element 3 and the medium pipe 4 can be easily distinguished from each other by their different types of connection.

In this configuration, the heat exchanger 2 has two separate pipes as a structure for guiding the medium pipe 4 and the electric heating element 3, which are each adjacent to each other and alternate in sequence. The structures serve as a support for the components 3, 4 and also produce a compact manufacturing component which simplifies the manufacture of the device. Primarily, it is clearly visible that the structure is located in the wall of the heat exchanger 2 and thus that the electric heating element 3 and the medium pipe 4 are embedded in the heat exchanger 2.

In the second configuration of the heat exchanger 2 in FIG. 3, two electric heating elements 3, 3′ are provided which are arranged one behind the other. This is evident from the fact that connecting contacts matching with both heating elements 3, 3′ are arranged next to each other along the longitudinal extension of the heat exchanger 2. The medium pipe 4 has its end sections extending out of the heat exchanger 2 in the direction of each of the two end faces of the heat exchanger 2. In this configuration, further access areas (or openings) therefore have to be provided in the heat exchanger 2.

1. A device for heating a medium and air, comprising:
a heating source, a heat exchanger, at least one electric heating element, and at least one medium pipe, wherein:
the heating source generates thermal energy by the combustion of a fuel-air-mixture,
the heat exchanger serves to heat air passed along an exterior side,
the heat exchanger has an interior space into which flue gas generated during combustion of the fuel-air-mixture flows,
the heat exchanger has a fin structure on the exterior side,
the heat exchanger transmits the thermal energy produced by the heating source to the medium pipe,
the electric heating element generates thermal energy,
the heat exchanger having integral structures for at least partially accommodating the electric heating element and the medium pipe,
the medium pipe is guided around the interior space of the heat exchanger, and
the electric heating element is guided around the interior space of the heat exchanger.

2. The device according to claim 1, wherein
the medium pipe and the electric heating element are guided parallel to each other.

3. The device according to claim 1, wherein
the medium pipe and the electric heating element are in thermal contact with each other.

4. The device according to claim 1, wherein
the integral structures of the heat exchanger are configured in a tubular shape.

5. The device according to claim 1, wherein
the device has two electric heating elements, and the integral structures at least partially accommodates the two electric heating elements.

6. The device according to claim 1, wherein
the heat exchanger is at least partially made of a die-cast or of a sintered material.

7. The device according to claim 1, wherein the medium pipe is guided concentrically around the interior space of the heat exchanger.

8. The device according to claim 1, wherein the electric heating element is guided concentrically around the interior space of the heat exchanger.
